(19) United States
(12) Patent Application Publication
(10) Pub. No.: US 2024/0092667 A1
(43) Pub. Date: Mar. 21, 2024

(54) MULTI-STEP METHOD FOR TREATING AQUEOUS EFFLUENTS

(71) Applicant: Nicolas MEUDAL, Pleubian (FR)

(72) Inventor: Nicolas MEUDAL, Pleubian (FR)

(21) Appl. No.: 18/262,346

(22) PCT Filed: Feb. 17, 2022
(86) PCT No.: PCT/EP2022/053945

§ 371 Date: Jul. 20, 2023

(30) Foreign Application Priority Data
Feb. 22, 2021 (FR) FR2101668

(51) Int. Cl. C02F 9/00; C02F 3/30

(52) U.S. Cl. CPC C02F 9/00; C02F 3/30; C02F 2209/40; C02F 2301/046

(57) ABSTRACT

Method for treating aqueous effluents, comprising the following steps: a) simultaneously feeding the aqueous effluents into at least two basins comprising at least one upstream basin and at least one intermediate basin in the flow direction of the aqueous effluents, the basins being in fluid connection and in series with one another; b) biologically treating, in a fluid bed, the aqueous effluents to be treated in the at least two basins; c) transferring at least one portion of the biologically treated aqueous effluents to a de-aerator; d) de-aerating the biologically treated aqueous effluents in the de-aerator; e) recirculating at least one portion of the de-aerated aqueous effluents to at least the upstream basin and preferably the at least two basins.

The present invention relates, in general, to the field of treatment of aqueous liquid effluents, in particular wastewater, with a view to its cleaning or purification.

More particularly, the present invention relates to a method for purifying wastewater comprising carbonaceous and nitrogenous materials, by a biological treatment.

Indeed, the treatment of aqueous effluents or wastewater coming from human activities is a matter of concern for authorities and citizens. Many standards and regulations now prevent the discharge of these effluents into the environment without any treatment. However, existing treatments often require large and expensive facilities which are a burden for communities and industrial companies.

Devices for treating aqueous effluent are known in the prior art, in which packing elements provided with a biological material are suspended in the aqueous effluents, in such a way as to remove polluting compounds therefrom. For example, document U.S. Pat. No. 9,896,363 describes a fluidised bed biofilm reactor for a wastewater treatment system.

On the other hand, this device has, in particular, the disadvantage of requiring large and expensive facilities; see, in particular, the second figure of that document. An object of the invention is to reduce the size and cost of aqueous effluent treatment facilities while maintaining a high level of purity of the biologically treated effluents.

To achieve this, a first aspect of the invention relates to a method for treating aqueous effluents, comprising the following steps:
a) simultaneously feeding aqueous effluents into at least two basins comprising at least one upstream basin and at least one intermediate basin in the flow direction of the aqueous effluents, in fluid connection and in series with one another;
b) biologically treating, on a fluidised bed, aqueous effluents to be treated in the at least two basins;
c) transferring at least one portion of the biologically treated aqueous effluents to a deaerator;
d) deaerating the biologically treated aqueous effluents in the deaerator;
e) recirculating at least one portion of the deaerated aqueous effluents to at least the upstream basin and preferably the at least two basins.

The present method can optimise the biological conditions in the upstream basin and the intermediate basin and thus treat a high flow rate of aqueous effluent in a device of reduced size.

Advantageously, the present method further comprises an air injection step f), preferably exclusively into the at least one intermediate basin. Such a step f) enables a different biological treatment in the intermediate basin compared with the upstream basin. Air injection step f) can be carried out continuously or intermittently. For example, the quantity, flow rate or pressure of injected air is regulated according to a concentration of air or oxygen dissolved in the aqueous effluents during biological treatment.

Hence, the intermediate basin can mainly or exclusively carry out a first biological treatment using first bacteria and the upstream basin can mainly or exclusively carry out a second biological treatment using second bacteria. The first treatment can be a nitrification treatment and the second treatment can be a denitrification treatment.

Advantageously, the present method further comprises a step g) of transferring the deaerated aqueous effluents to at least one downstream basin and wherein the steps a) of feeding aqueous effluents and b) biological treatment are also carried out in the downstream basin. This makes it possible to further optimise the efficiency of the treatment of aqueous effluents, in particular with respect to the nitrogenous compounds.

Preferably, a biological treatment is carried out in the upstream basin without an injection of air and can therefore correspond to the second treatment carried out by the second bacteria.

Advantageously, a feed flow rate of aqueous effluents differs between the upstream basin and the intermediate basin. This makes it possible to optimise the biological conditions in each basin.

Advantageously, a recirculation flow rate of at least one portion of the aqueous effluents differs between the upstream basin and the intermediate basin. This makes it possible to optimise the biological conditions in each basin.

Advantageously, the upstream basin receives a higher feed flow rate of aqueous effluents and/or a higher recirculation flow rate of at least one portion of the deaerated aqueous, which makes it possible to optimise the second treatment.

Advantageously, step c) of transferring the aqueous effluents to the deaerator is only carried out with aqueous effluents from the intermediate basin or from the intermediate basin furthest downstream, which makes it possible to deaerate only the biologically treated effluents, i.e. those having already undergone at least the first treatment and therefore able to be recirculated optimally after deaerating to at least the upstream basin and/or transferred to the downstream basin in order to undergo the second treatment.

Advantageously, deaerating step d) comprises or can be comprised in a step of decanting the biologically treated effluents in order to separate a solid from a supernatant and wherein the step of recirculating the deaerated aqueous effluents is only carried out on at least one portion of the supernatant liquid.

Advantageously, steps a) of feeding aqueous effluents and b) of biological treatment are also carried out in at least two intermediate basins and preferably three or more intermediate basins. The multiplication of intermediate basins, preferably fed with air according to step f), makes it possible to treat, in each basin, smaller volumes of aqueous effluents and therefore to create an optimal environment for the proper performance of the biological treatment. Preferably, at least one or at least two intermediate basins from three or four intermediate basins receive air in accordance with step f). For example, all the intermediate basins receive air in accordance with step f).

Preferably, recirculation step e) is also carried out, to at least one and for example all the intermediate basins.

Preferably, air and in particular oxygen dissolved in the biologically treated aqueous effluents is at least partially deaerated during deaerating step d).

In a normal operating mode, the present method can be carried out continuously, and all of these steps can be carried out simultaneously.

A second aspect of the present invention relates to a device for treating aqueous liquid effluents, comprising:
a) at least two basins comprising at least one upstream basin and at least one intermediate basin in the flow direction of the aqueous effluents, in fluid connection and in series with one another;
b) a deaerator suitable for deaerating aqueous effluent and in fluid connection with the intermediate basin;
c) feeding means for aqueous effluents to be treated, connected to the upstream basin and to the intermediate basin;
d) recirculation means suitable for ensuring recirculation of deaerated effluents from the deaerator to at least the upstream basin and preferably to the at least two basins.

Such a device can efficiently treat a high flow rate of aqueous effluents in a facility of reduced size.

Preferably, the present device comprises at least two intermediate basins, preferably three or more, so as to more easily optimise the biological conditions in all the basins.

Preferably, air injection means are provided for injecting air only into the one or more intermediate basins.

Preferably, the present device further comprises a downstream basin located downstream of the deaerator and in fluid connection with the deaerator. For example, the deaerator is configured to only carry out a transfer and/or a recirculation of deaerated aqueous effluent, in other words without substantial presence of sludge or solids.

Preferably, the downstream basin is connected to the feed means for aqueous effluents to be treated.

A third aspect of the present invention relates to a method for treating aqueous effluents comprising: a denitrification step, a nitrification step, a step of deaerating biologically treated aqueous effluents and a step of recirculating deaerated effluents to the denitrification step. These steps can be carried out upstream or downstream, in the direction of flow of the aqueous effluents.

Hence, the denitrification step can be carried out downstream of the nitrification step by recirculating deaerated aqueous effluents. This makes it possible to optimise the treatment method by taking advantage of the biological conditions existing downstream.

Preferably, another denitrification step is carried out downstream of the deaerating step. Preferably, a step of feeding aqueous effluent is carried out in order to feed the nitrification and denitrification steps. This third aspect of the invention can benefit from all the advantageous or preferential aspects of the first aspect of the invention.

Other features and advantages of the present invention will become more clearly apparent on reading the following detailed description of an embodiment of the invention, given by way of not-limiting example, and illustrated by the appended drawings, in which:

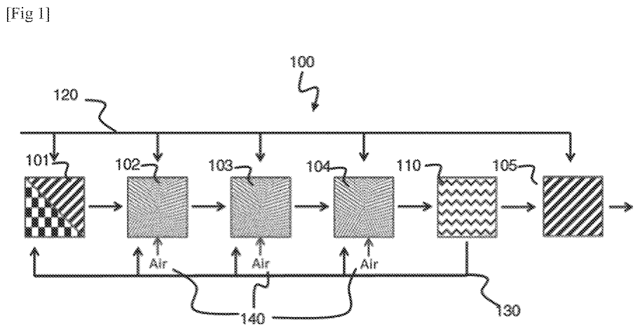

FIG. 1 shows a block diagram of a device for treating aqueous effluents according to the present invention.

The present invention relates to a method for continuously treating aqueous effluent, the aqueous effluents possibly coming from a domestic aqueous effluent collection network, in other words wastewater, from an industrial facility or from an agricultural facility, for example in the field of livestock or fish farming.

The method according to the present invention makes it possible to remove at least ammonia and carbon from aqueous effluents and optionally phosphorus (method referred to as BNR: Biological Nutrient Removal), so as to enable the discharge of treated aqueous effluents into the environment in compliance with environmental standards. The present treatment method is, for example, included between a primary treatment which can comprise filtration and/or decantation steps, and a tertiary treatment that may also include decantation steps or other physico-chemical treatments.

The method according to the present invention preferably uses a fluidised bed biological treatment, in other words carried out in vessels comprising packing elements on which bacteria can grow enabling a treatment of aqueous effluents, as is known to a person skilled in the art. Reference is made to the following publication, describing the operation of a so-called fluidised bed bioreactor: Ødegaard, H.; Rusten, B.; Westrum, T. (October 1994). “A new moving bed biofilm reactor—applications and results”. Water Science and Technology. 29 (10-11). The present invention preferably excludes any treatment by activated sludge.

According to the present treatment method, two different biological treatments are carried out on the nitrogenous compounds contained in the aqueous effluents by different types of bacteria present in the aqueous effluents and/or in the present treatment device.

A first so-called nitrification treatment consists mainly in the oxidation of ammonia into nitrite by first bacteria, the nitrite ions then being oxidised into nitrates. This first type of treatment is carried out under aerobic conditions, in other words in the presence of oxygen dissolved in the aqueous effluents during treatment.

A second, so-called denitrification, treatment consists mainly of reducing the nitrates to molecular nitrogen by second bacteria. This type of treatment is carried out under anoxic conditions, in other words in the absence of oxygen, but in the presence of nitrates from the first treatment. These two treatments both also consume carbonaceous material contained in the aqueous effluents to be treated, in particular the first treatment.

Without being bound by any particular theory, the applicant has noted that the biological conditions of the treatments carried out according to the prior art are rarely ideal. In particular, the optimum ratio between carbonaceous material and nitrogenous material and the presence or absence of oxygen required by the first or second bacteria carrying out the biological treatments, are rarely satisfied in the existing facilities.

The present invention can, in general, improve the conditions of each of these two biological treatments, so as to produce an effective treatment of the ammonia and carbon of the aqueous effluents to be treated and therefore so as to treat a large volume of aqueous effluents in an inexpensive treatment device of reduced size. Phosphorus compounds can also be treated within the scope of the present invention.

With reference to FIG. 1, a device 100 for treating aqueous liquid effluents according to the present invention comprises an upstream tank or basin 101, three intermediate tanks or basins 102, 103, 104, a deaerator 110 and a downstream basin 105.

The basins 101, 102, 103 and 104 are mounted in series, in other words so that a stream of aqueous effluents can flow from the upstream basin 101 to the last intermediate basin 104.

The deaerator 110 is disposed downstream of the last intermediate basin 104, in other words a treatment module suitable for deaerating the aqueous effluents coming from the intermediate basin 104 furthest downstream. The downstream basin 105 can be located downstream of the deaerator 110.

All of the basins 101, 102, 103, 104 and 105 are intended to carry out a biological treatment of the aqueous effluents and, for this purpose, contain packing elements or modules which can float in the aqueous effluents and suitable for receiving bacteria.

In addition, feed means 120 are provided for feeding the basins 101, 102, 103, 104 with aqueous effluents to be treated, from a source of aqueous effluents, such as a wastewater collection network of a commune and/or an agricultural, tourist or industrial facility. For this purpose, the feed means can comprise pumps or pumping means, as well as one or more filters, as known to a person skilled in the art.

Recirculation means 130 are provided in order to recirculate the deaerated aqueous effluents from the deaerator 110 to the basins 101, 102, 103 and 104. Preferably, only aqueous effluents comprising no solids are recirculated and solids and/or the sludge can be discharge from the deaerator 110 for recycling or reuse. These recirculation means can comprise one or more pumps, as well as filters, valves, flow meters and suitable pipes.

Finally, air injection means 140 are provided for supplying a portion of the basins, for example the intermediate basins 102, 103 and 104 in the example of FIG. 1. Preferably, at least the first basin 101 or upstream basin has no injection of air, as well as the downstream basin 105. These air injection means can be adjusted to compress and inject the air outside the present device or else separately supplied compressed air. The air injection means can enable continuous, intermittent or regulated air injection, for example according to the existing biological conditions and/or the biological treatment carried out in the one or more intermediate basins 102, 103 and 104.

Pumping means can thus be provided between each module in order to ensure the circulation of effluents from upstream (basin 101) to downstream (deaerator 110 and downstream basin 105) and/or the flow of aqueous effluents in the present treatment device 100 can be ensured by the flow of aqueous effluents to be treated created by the feed means 120.

The basins 101, 102, 103, 104 and 105 can comprise any type of basin for fluidised bed biological treatment known to a person skilled in the art. Preferably, this involves basins configured to ensure a rotary movement of the aqueous effluents. More preferably, it involves basins of the type described in document WO2020083743.

The deaerator 110 comprises any type of treatment module or basin capable of reducing a concentration of gas of aqueous effluents coming from the basin 104. The gas removed is preferably oxygen coming from the air injection means 140 and can also comprise carbon dioxide from the biological treatment carried out in the intermediate basins 102, 103 and 104.

For example, the deaerator 110 can be an open basin, with or preferably without stirring means or else a decanter, for example of a decanter-thickener, lamellar decanter, scraper decanter or even a tetrahedral decanter.

In operation, aqueous effluents to be treated are conveyed by the feed means 120, preferably continuously, to the basins 101, 102, 103 and 104. The aqueous effluents do not generally contain oxygen, but are rich in carbonaceous material and ammonia. In addition, the first basin 101 does not receive air injection, in other words the aqueous effluents are at least partially under anaerobic conditions symbolised by the squares in FIG. 1. Recirculation of deaerated effluents from the deaerator 110, rich in nitrate and poor in oxygen, will enable the anoxic conditions symbolised by the stripes in FIG. 1.

Hence, the upstream basin 101 can enable a privileged growth of the second bacteria ensuring implementation of the second treatment, and can therefore reduce the quantity of nitrogen in the aqueous effluents by transforming nitrate ions into molecular nitrogen which is released into the atmosphere. The biological conditions are not favourable for the growth of the first bacteria, which therefore do not enter into competition with the second bacteria and the second bacteria can then grow optimally.

The aqueous effluents coming from the upstream basin 101 are then mixed with the aqueous effluents to be treated in the intermediate basins 102, 103 and 104, due to the feed means 120. The air injection means 140 enable a large increase in the concentration of air and thus oxygen dissolved in the aqueous effluents. The first bacteria can grow optimally and carry out the first treatment, in other words the nitrification of ammonia into nitrite. The second bacteria with slower growth are not favoured and do not take part in the biological treatment performed in the intermediate basins, or only marginally.

The recirculation means 130 can also ensure a recirculation of the deaerated aqueous effluents to one or more intermediate basins 102, 103, 104 and preferably to at least the first intermediate basin 102, in other words to at least the intermediate basin located immediately downstream of the upstream basin 101.

For example, the feed flow rate of each of the basins can differ, in other words a staged feed can be produced. Hence, the feed flow rate can be largest for the first basin 101, for example at least 50% of the total feed flow rate, in other words entering, at least 60% or even at least 70% and decreases going downstream, to the third intermediate basin 104.

By way of example, if the feed is carried out to all the intermediate basins, the upstream basin 101 can receive 40% to 70% of the total feed flow rate, for example 60%, the first intermediate basin 102 can receive 20 to 40% of the flow rate for example 30%, the second intermediate basin 103 can receive 1% to 20% of the flow rate, for example 5%, and the third intermediate basin 104 can receive 1 to 20% of the flow rate, for example 5%.

A limited feed of aqueous effluent to be treated from the intermediate basins, in particular the intermediate basins 103 and 104 furthest downstream, can ensure a good feed of carbonaceous material, which is favourable for the growth of the first bacteria and therefore to the first treatment.

In addition, the recirculation of deaerated effluents can only be carried out towards the upstream basin 101, in which case the recirculation flow rate can represent 20 to 50% of the feed flow rate.

Preferably, the recirculation can be carried out for all basins located upstream of the deaerator 110. In this case, the recirculation of deaerated effluents is preferably carried out in a staged manner, in other words the deaerated aqueous effluents are recirculated, with different flow rates, to the upstream basin 101 and to the intermediate basins 102, 103 and 104. The recirculation flow rate conveyed to each of the intermediate basins 102 to 104 can differ, at least partially.

For example, the upstream basin 101 can receive at least 20%, at least 30% or at least 40% of the recirculation flow rate. The first intermediate basin 102 can then receive at least 20% or at least 30% of the recirculation flow rate. The other intermediate basins can each receive 5 to 20% and for example 10% of the recirculation flow rate.

The deaerated aqueous effluents, in other words coming from the deaerator 110, are also partially transferred to the downstream basin 105, for example for half of the total flow rate, in other words the feed flow rate can be substantially equal to the recirculation flow rate and to the flow rate of deaerated aqueous effluents transferred to the downstream basin 105. For example, in the case of a feed flow rate of 10 m³/h, the flow rate of recirculated deaerated effluents can be 10 m³/h and the flow rate of gaseous effluents transferred to the downstream basin 105 can also be 10 m³/h.

The deaerated aqueous effluents are depleted of oxygen and rich in nitrates, and the biological conditions in the downstream basin 105 are thus optimum for the growth of the second bacteria and for carrying out a denitrification according to the second treatment, in the downstream basin 105.

Downstream of the downstream basin 105, other treatments can be carried out, for example physico-chemical treatments, or else the biologically treated effluent can be released into the environment, in accordance with the standards in force.

Hence, by optimising the biological conditions in each basin, the present method makes it possible to efficiently treat a large flow rate of aqueous effluents in a facility of reduced size, while obtaining optimum treatment performance, in particular on the nitrogenous and carbonaceous compounds contained in the aqueous effluents to be treated.

It should be noted that the device according to the invention is not limited to three intermediate basins 102, 103 and 104, but can comprise at least one intermediate basin and preferably two and, more preferably, four intermediate basins or more. In general, the multiplication of basins is favourable to the optimisation of the present method.

The staged feed and/or staged recirculation flow rate can then be added or divided according to the number of basins. For example, in the absence of intermediate basin 104 furthest upstream, the remaining intermediate basin 103 can receive the feed and/or recirculation flow rates of the intermediate basins 103 and 104.

Similarly, if one or more intermediate basins are added, then the total feed and/or recirculation flow rate of the intermediate basins 103 and 104 can be divided into three, or more, depending on the number of intermediate basins. Preferably, the feed and/or recirculation flow rates of the upstream basin 101 remain similar to the above-cited values. Similarly, the first intermediate basin 102 can also maintain an identical or similar feed and/or recirculation flow rate, whatever the total number of intermediate basins.

It is also possible to add a second upstream basin having no air injection, between the upstream basin 101 and the first intermediate basin 102. This can increase the efficiency of the second treatment, in particular when the recirculated aqueous effluents are rich in nitrates. The feed and/or recirculation flow rates of the upstream basin 101 can then be divided into two.

It is also possible to add a second downstream basin after the second downstream basin 105, so as to increase the efficiency of the second treatment, in particular when the deaerated aqueous effluents are rich in nitrates.

It is understood that various modifications and/or improvements that are obvious to a person skilled in the art can be applied to the various embodiments of the invention described in the present description, without going beyond the scope of the invention defined by the attached claims.

1. A method for treating aqueous effluents, comprising the following steps:
a) simultaneously feeding aqueous effluents into at least two basins comprising at least one upstream basin and at least one intermediate basin in the flow direction of the aqueous effluents, in fluid connection and in series with one another;
b) biologically treating, on a fluidised bed, aqueous effluents to be treated in the at least two basins;
c) transferring at least one portion of the biologically treated aqueous effluents from the intermediate basin to a deaerator;
d) deaerating the biologically treated aqueous effluents in the deaerator;
e) recirculating at least one portion of the deaerated aqueous effluents to at least the upstream basin and preferably the at least two basins,
further comprising an air injection step f), preferably exclusively in the at least one intermediate basin.

2. The treatment method according to claim 1, further comprising a step g) of transferring the deaerated aqueous effluents to at least one downstream basin and wherein the steps a) of feeding aqueous effluents and b) biological treatment are also carried out in the downstream basin.

3. The treatment method according to claim 1, wherein a feed flow rate of aqueous effluents differs between the upstream basin and the intermediate basin.

4. The treatment method according to claim 1, wherein recirculation step e) is carried out to the at least two basins and a recirculation flow rate of at least one portion of the deaerated aqueous effluents differs between the upstream basin and the intermediate basin.

5. The treatment method according to claim 4, wherein the upstream basin receives a higher feed flow rate of aqueous effluents and/or a higher recirculation flow rate of at least one portion of the deaerated aqueous effluents.

6. The treatment method according to claim 1, wherein deaerating step d) comprises a step of decanting the biologically treated effluents in order to separate a solid from a supernatant and wherein the step of recirculating the deaerated aqueous effluents is only carried out on at least one portion of the supernatant liquid.

7. The treatment method according to claim 1, wherein the steps a) of feeding aqueous effluents and b) of biological treatment are also carried out in at least two intermediate basins and preferably three intermediate basins or more.

8. A device for treating aqueous effluents, comprising:
a) at least two basins comprising at least one upstream basin and one intermediate basin in the flow direction of the aqueous effluents, in fluid connection and in series with one another and intended for carrying out a biological treatment on a fluidised bed;
b) a deaerator suitable for deaerating aqueous effluent and in fluid connection with the intermediate basin;
c) feeding means for aqueous effluents to be treated, connected to the upstream basin and to the intermediate basin;
d) recirculation means suitable for ensuring recirculation of deaerated effluents from the deaerator to at least the upstream basin and preferably to the at least two basins;
e) air injection means suitable for injecting air, preferably exclusively into the intermediate basin.
